(19) United States
(12) Patent Application Publication
(10) Pub. No.: US 2015/0213010 A1
(43) Pub. Date: Jul. 30, 2015

(54) STORAGE SYSTEM WITH DISTRIBUTED DATA SEARCHING

(71) Applicant: SAGE MICROELECTRONICS CORP., Saratoga, CA (US)

(72) Inventors: Jianjun Luo, Los Gatos, CA (US); Shi Wang, Zhejiang (CN)

(73) Assignee: SAGE MICROELECTRONICS CORP., Saratoga, CA (US)

(21) Appl. No.: 14/168,446

(22) Filed: Jan. 30, 2014

(51) Int. Cl. G06F 17/30

(52) U.S. Cl. CPC G06F 17/301

(57) ABSTRACT

A storage system includes a host, a storage array controller coupled to the host, and one or more storage device with self-search engine coupled to the storage array controller. The one or more storage device with self-search engine responsive to one or more keywords from the host through the storage array controller and operable to search for the one or more keywords substantially concurrently.

### BACKGROUND

Various embodiment of the invention relate generally to storage systems and particularly to storage systems using storage device engines.

Storage systems have continued to grow in size, capacity, volume of information, and input/output requirements. There is ample evidence showing this growth to only continue to become greater. With the growth of storage systems comes certain challenges, some of which are performance and throughput. For example, a greater number of storage devices need to searched when looking up information therein. Such searches are time-consuming because a greater number of storage devices need be searched as additional storage devices are added. Therefore, performance is compromised because additional input/output operations are required. Additionally, throughput is reduced because a bottleneck is created when accessing additional storage devices.

There is therefore a need for a high-performance and high through-put storage system.

### SUMMARY

Briefly, a storage system includes a host, a storage array controller coupled to one or more host, and one or more storage device with self-search engine coupled to the storage array controller. The one or more storage device with self-search engine responsive to one or more keywords from the host through the storage array controller and operable to search for the one or more keywords substantially concurrently.

A further understanding of the nature and the advantages of particular embodiments disclosed herein may be realized by reference of the remaining portions of the specification and the attached drawings.

### BRIEF DESCRIPTION OF THE DRAWINGS

FIGS. 1A-1E and 2-4 show a storage system and its operation, in accordance with methods and embodiments of the invention.

FIGS. 5-7 show methods of searching, in accordance with various methods of the invention.

### DETAILED DESCRIPTION OF EMBODIMENTS

The following description describes a storage system. The storage system includes storage devices with self-search engines accessed by a host through a storage array controller. In an embodiment of the invention, a keyword search of the storage devices avoids searching each storage device.

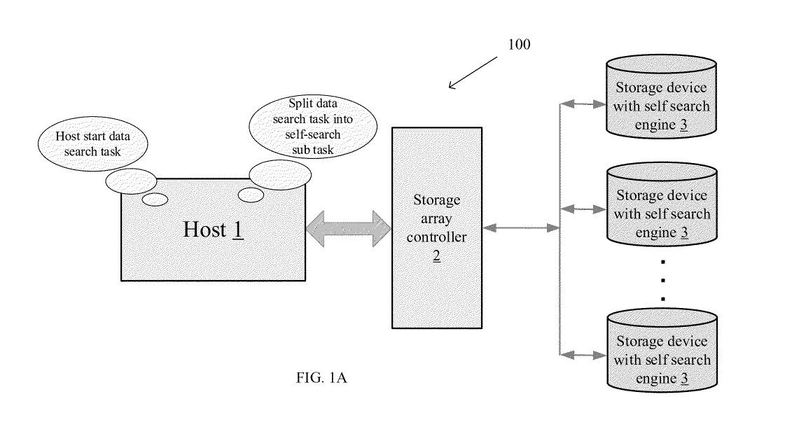

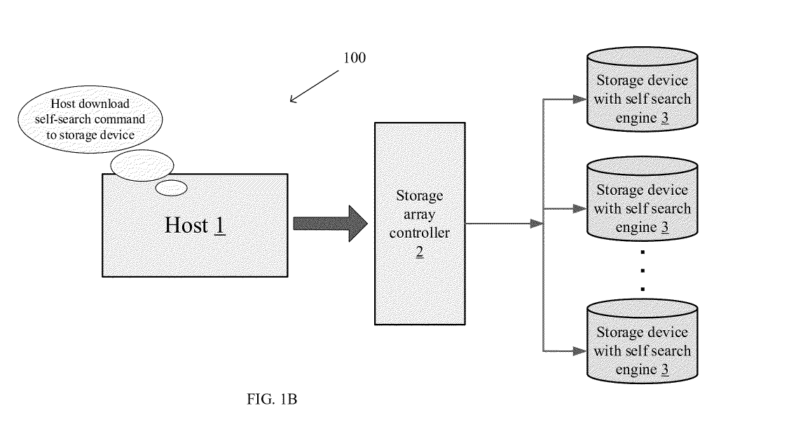

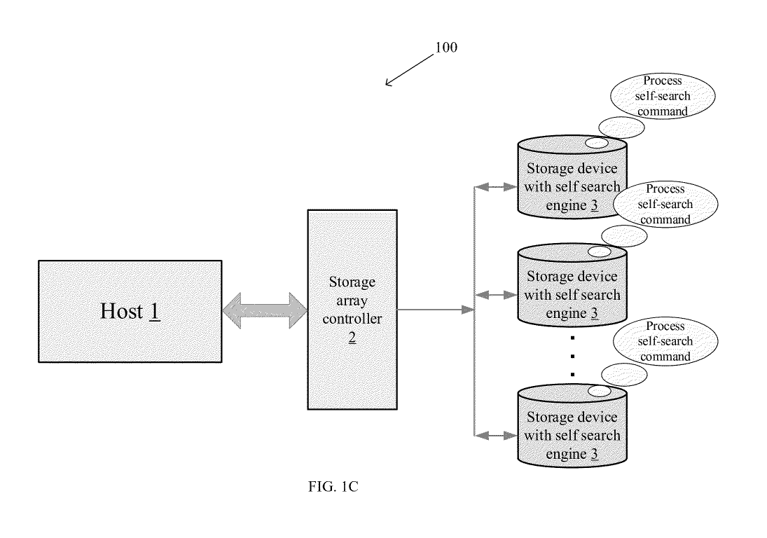

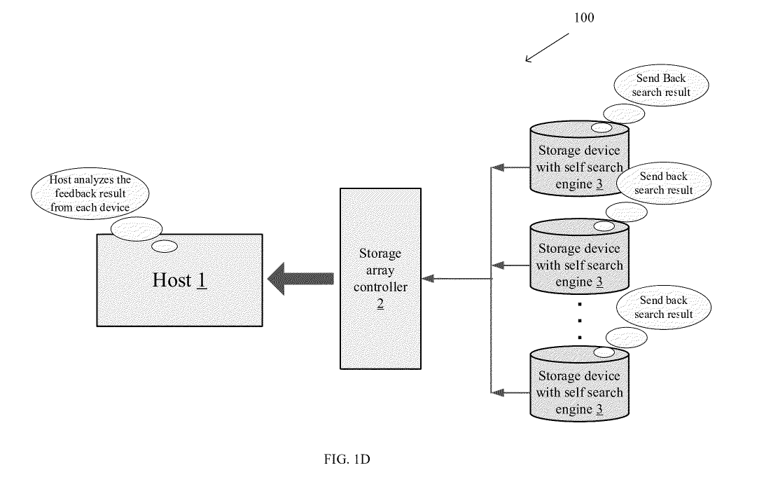

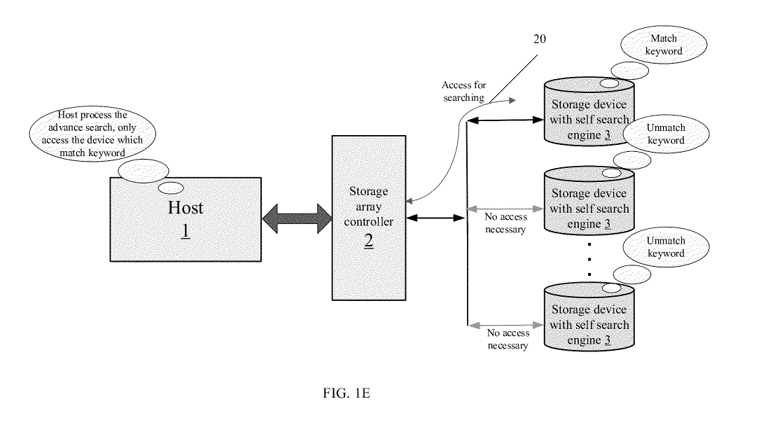

FIGS. 1A-1E shows a storage system 100 and its operation in accordance with embodiments and methods of the invention. Referring now to FIG. 1A, a storage system 100 is shown in accordance with an embodiment of the invention. The system 100 is shown to include a host 1, a storage array controller 2, and a number of storage devices with self-search engines 3. The host 1 is shown coupled to the storage array controller 2 and the storage array controller 2 is shown coupled to the storage devices with self-search engines 3. The host 1 accesses and/or communicates with the storage devices with self-search engines 3 through the storage array controller 2. An example of a host 1 is a web server, an example of a storage device with self-search engine 3 is any array of SSD with self-search engine.

In accordance with a method and apparatus of the invention, the host 1 causes searching, through the storage array controller 2, for a keyword or other targets within the storage device with self-search engines 3. Each of the storage device with self-search engines 3 is searched individually and in parallel (or substantially concurrently) relative to one another such that each engine 3 is capable of and performs its own search. The search of all of the engines 3 consumes substantially the same amount of time as it takes to search only one of the engines because of the parallel access of the engines by the controller 2. When a match of a target or keyword is detected by one of the engines 3, that engine reports the search result to the controller 2, which ultimately reports back to the host 1. But for engines 3 that do not detect a match, no access other than sending the target to them is needed.

More specifically, relative to the operation of the system 100, a distributed data searching flow is shown from FIG. 1A to FIG. 1E as follows. Referring to FIG. 1A, the host 1 firstly initiates a data search task. As shown in FIG. 1B, which can be processed by individual self-search storage devices 3. As shown in FIG. 1B, the host 1 downloads (sends) a self-search command to the storage device with self-search engines 3, through the controller 2, as shown by the direction of the arrows in FIG. 1B.

As shown in FIG. 1C, the storage device with self-search engines 3 receive the self-search command sent by the host 1 and process the same (search for the keyword).

In FIG. 1D, The storage device with self-search engines 3 send the search result back to host 1, through the controller 2. The host 1 analyzes the result of the search from each of the engines 3 and chooses the target storage device which has the matched keyword. As shown in FIG. 1E, the host 1 only accesses the target storage device which was chosen at FIG. 1D. This access is shown by the line 20 to emphasize that only the storage device with the match is accessed and the remaining storage devices are not. The host 1 then processes this advanced search. Examples of ways the host 1 processes, without limitation, are filter combination keyword, structuring the readable information, in FIG. 1E. In this way, the I/O throughput of the storage system 100 is reduced, and the keyword search task can be processed by multiple storage devices concurrently. Accordingly, system performance is improved because I/O throughput is reduced and through parallel processing, the search task may be done concurrently thus faster

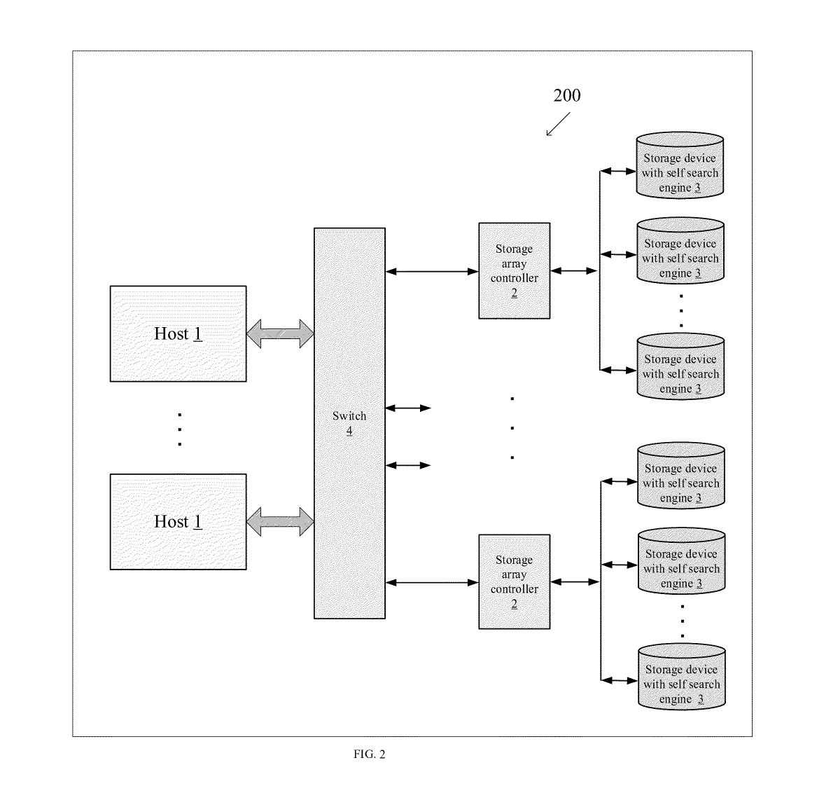

FIG. 2 shows a storage system 200, in accordance with an embodiment of the invention. The system 200 includes multiple hosts 1, coupled through a switch 4, to multiple controllers 2. The controllers 2 are shown coupled to a distinct group of storage device with self-search engines 3. The switch 4 selects one of the hosts 1 to communicate with one or more of the controllers 2, which in turn communicate with a respective group of storage device with self-search engines 3. Having multiple hosts and multiple controllers 2 allows further parallel processing of the storage device with self-search search engines 3. For example, in embodiments using two hosts and two controllers, two keywords may be communicated to and searched by the storage device with self-search engines 3 substantially concurrently because two distinct groups of the engines 3 may be searched at the same time. It is understood that while two hosts, two controllers and two groups of engines are shown in FIG. 2, any number of the same is contemplated.

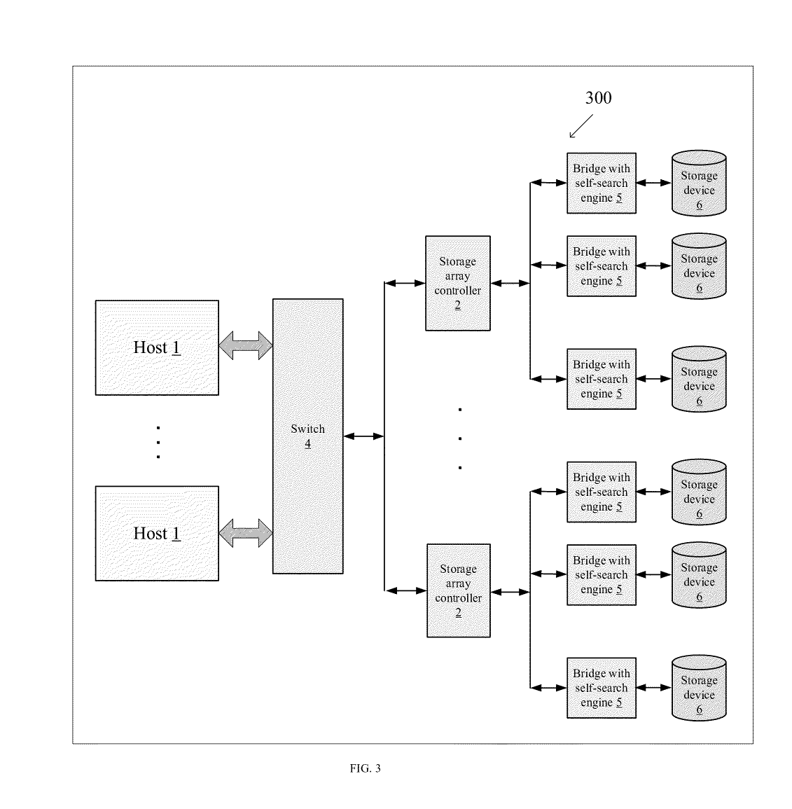

FIG. 3 shows a storage system 300, in accordance with an embodiment of the invention. System 300 is analogous to system 200 except that the storage devices do not include a self-search engine and in this respect can be conventional storage devices. More specifically, in system 300, a bridge with self-search engine 5 is shown coupled between the controller 2 and a storage device 6. Accordingly, the storage devices 6 do not have self-search capability as the embodiment of FIG. 2, for example, and the bridge with self-search engine 5 performs the search of a keyword in the information stored in the storage device 5. With the use of the bridge with self-search engine 5, the storage system can use conventional storage devices, such as hard disk drive (HDD), solid state disk (SSD), and other known storage devices. As in the case of system 200, multiple controllers 2 are shown coupled between the switch 4 and the storage devices 6 except that this coupling is through the bridge with self-search engines 5 in system 300. Similar to system 200, the bridge with self-search engines 5 may be grouped together in accordance with the grouping of the storage devices 6,

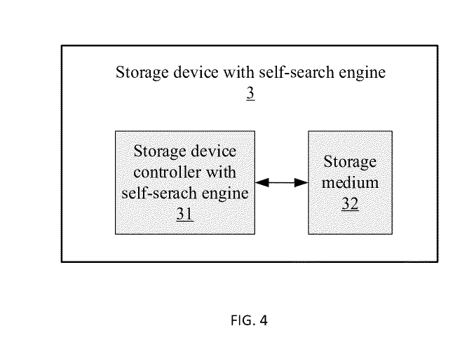

FIG. 4 shows further details of one of the storage device with self-search engines 3 of the various embodiments of the invention. The storage device with self-search engines 3 is shown to include a storage device controller with self-search engine 31 and a storage medium 32. The storage device controller with self-search engine 31 and the storage medium 32 are shown coupled to each other. The engine 31 searches the storage medium 32 for a keyword upon receiving instructions, such as a command, from the controller 31 to do so. Examples of the storage medium 32 include, without limitation, Flash Memory, Security Digital Memory Card (SD), embedded Multi Media Card (eMMC) and magnetic medium.

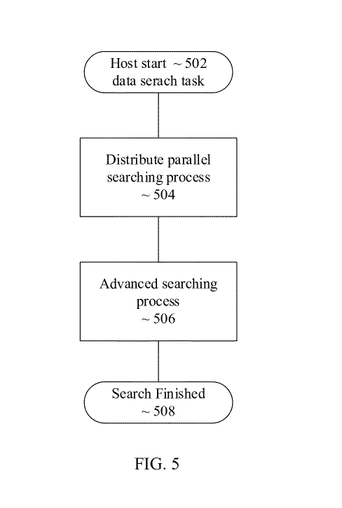

FIGS. 5-7 show various flow charts of the processes performed by the storage systems of FIGS. 1A through FIG. 4, in accordance with methods of the invention. In FIG. 5, the host 1 starts a data search task 602 and thereafter, at step 604, the host 1 distributes parallel searching process to various storage device with self-search engines through one or more of the storage array controllers 2. Next, at step 506, the search process 506 is performed under the direction of the controller 2 of the engines 3 and at 508, the search is completed.

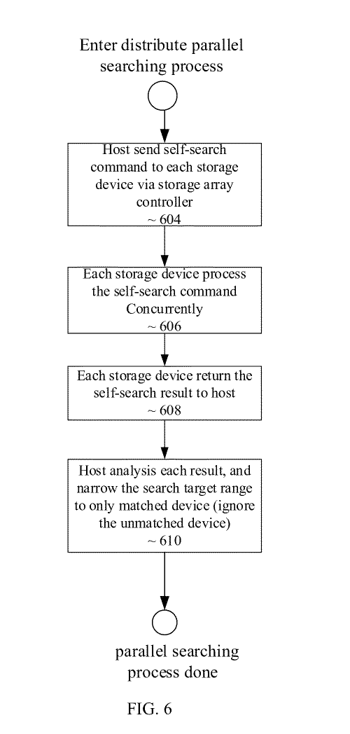

FIG. 6 shows a method of parallel search processing performed by the embodiment of FIG. 1E. In this method, as discussed relative to FIG. 1E herein, the search process is distributed. At step 604, the host 1 sends a self-search command to each of the storage device with self-search engines 3 through the storage array controller 2. Next, at step 606, each of the engines processes the self-search command by searching for the keyword in parallel or substantially concurrently. Next, at step 608, either each of the engines 3 or only the engine 3 that has a match return the results of their search to the host 1 through the controller 2. Subsequently, at step 610, in embodiments and methods where the host 1 analyzes the searches, the host 1 narrows the search target range to only the engines with matches and ignores the result reported from the remaining engines and the process ends thereafter.

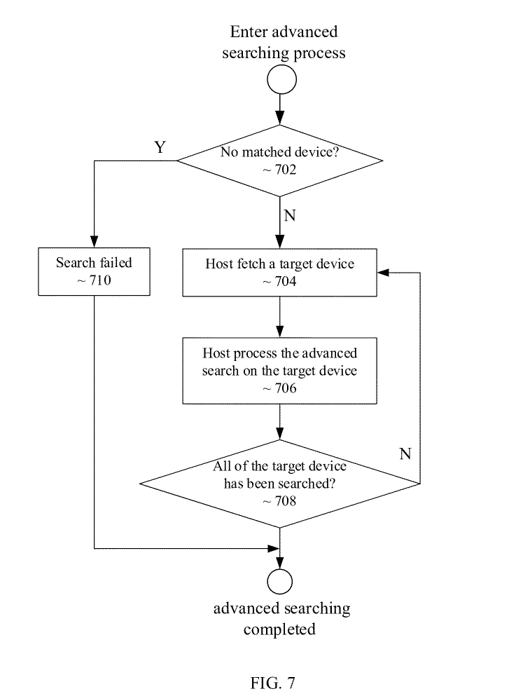

FIG. 7 shows the process for searching, in accordance with another embodiment of the invention. At step 702, after the search process has been initiated by the host 1, a decision is made as to whether a match has been detected by the storage device with self-storage engine(s) 3 and if so, the process continues to step 704, otherwise, since no match has been detected, the search is considered to have failed at step 710. At step 704, the host 1 fetches a target device (one or a distinct group of storage device with self-search engine 3). Next, the host 1 processes the advanced search on the target device at step 706 followed by determining whether or not all of the target devices have been searched and if so, the search process ends, otherwise, the process repeats starting from the step 804.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A storage system comprising:
at least one host;
at least one storage array controller coupled to the host;
at least one storage device with self-search engine coupled to the storage array controller responsive to one or more keywords from the host through the storage array controller and operable to search for the one or more keywords substantially concurrently.

2. The storage system of claim 1, wherein the host is operable to initiate the search by a command.

3. The storage system of claim 1, further including more than one storage array controller causing more than one keyword to be searched concurrently.

4. The storage system of claim 1, wherein the storage device with self-search engine includes a storage device controller with self-search engine and a storage medium and the storage device controller with self-search engine is coupled to the storage medium.

5. The storage system of claim 1, wherein the host is operable to start a data search task.

6. The storage system of claim 5, wherein each of the one or more storage device is responsive to a particular search task.

7. The storage system of claim 1, wherein the one or more storage device with self-search engines is responsive to one or more keywords from the host through the storage array controller and operable to search for the one or more keywords substantially concurrently.

8. The storage system of claim 1, further including more than one host and more than one storage array controller, the storage system further including a switch coupled between the more than one host and more than one storage array controller and operable to select one of the hosts to communicate with one of the storage array controllers.

9. The storage system of claim 8, further including more than one storage device with self-search engines coupled to the more than one storage array controller, wherein each of the more than one storage array controllers is coupled to a distinct one of the more than one storage device with self-search engines.

10. A storage system comprising:
at least one host;
at least one storage array controller coupled to the at least one host;
at least one bridge with self-search engine coupled to the at least one storage array; and
at least one storage device coupled to the at least one bridge with self-search engine, the at least one bridge with self-search engine responsive to one or more keywords from the host through the storage array controller and operable to search for the one or more keywords substantially concurrently.

11. The storage system of claim 10, wherein each of the at least one storage devices is coupled to a respective one of the at least one bridge with self-search engine.

12. The storage system of claim 10, wherein each of the at least one bridge with self-search engine is coupled to a respective one of the at least one storage device.

13. The storage system of claim 10, wherein each of the at least one storage devices is coupled to a respective one of the at least one host.

14. A method of searching in a storage system comprising:
Receiving at least one keyword from a host;
Distributing the at least one keyword to one or more storage devices; and
Concurrently searching the one or more storage devices for the at least one keyword.

15. The method of claim 14, further including reporting to the host a match of the at least one keyword within the one or more storage devices, wherein only the one of the one or more storage devices with the match provides the result of the match to a storage array controller for use by the host.
